(19) United States
(12) Patent Application Publication
(10) Pub. No.: US 2008/0222728 A1
(43) Pub. Date: Sep. 11, 2008

(54) Methods and interfaces for executable code analysis

(76) Inventors: Paula Natasha Chavez, Azille (FR); Daniel Leo Murphy, Azille (FR)

Correspondence Address: Paula N. Chavez;Suite 5, PMB 240, 11 Robert Toner Blvd., North Attleboro, MA, 02763, US

(21) Appl. No.: 11/713,714

(22) Filed: Mar. 5, 2007

(51) Int. Cl. G06F 11/00

(52) U.S. Cl. 726/24

(57) ABSTRACT

Described are methods of a server and for processing an email message. Also described are user interfaces. A user may forward unopened email message and/or URLs to a service provider for analysis of whether the unopened email message or URL is configured to download executable code. The service provider may operate with a server. The server may determine if executable code is present in the email message and/or is downloadable via a website. The executable code may be determined to be malicious. It is also described that after a service provider has determined whether the email message and/or the URL is configured to download malicious executable code, the user can receive an indication to that effect from the server.

### CROSS REFERENCDE TO RELATED APPLICATIONS

This non-provisional application is related to and claims priority from its provisional application, “METHODS AND INTERFACES FOR EXECUTABLE CODE ANALYSIS” filed Mar. 6, 2006, and which is herein incorporated by reference in its entirety.

### FIELD

Disclosed are methods and interfaces for executable code analysis and more particularly, for forwarding unopened email and/or a URL to a server to determine if the email and/or URL is configured to download malicious executable code.

### BACKGROUND

Internet users are becoming more susceptible to crimes and vandalism as Internet usage continues to increase. As Internet use has increased, junk mail or spam is less of a concern since the incidence of Internet crimes and vandalism has grown substantially. For example, email and users are warned not to open suspicious emails in their email inboxes since otherwise they may be victimized by stealth downloading of malicious executable code onto their computers. While many users are careful not to open emails from senders with whom they are not familiar, there may be situations where deleting unopened email messages due to concern of their origin is not practical. For example, some Internet based businesses rely on receiving email from new customers and even solicitors. Accordingly, they may be obliged to open emails from sources that are not known. Both, business and personal email accounts may receive email messages including executable code and other malicious payload that is intended to infect the computers or steal information from computers, or directly from the users.

To combat the wrongdoers on the Internet, there are many different automated technologies that are designed to automatically filter emails into categories, such as junk email and acceptable email. Additionally, firewalls and virus scanning software is recommended for computer users. Services are offered, particularly to organizations having many users, to process all incoming email to analyze it for malicious executable code, or “malcode.” However, average users, including small business and personal users must maintain their own diligence against malcode. Users are encouraged to update their automated software such as anti-virus, anti-keylogging, anti-phishing, anti-trojan software on their computers on a regular basis. Those users who do not regularly install patches and/or advanced security software run the risk of being affected by the newest malicious executable code and/or other malicious payload. While these automatic technologies are useful, a user's judgment remains a good filter as well. Wise email users are conditioned to delete messages without opening them if they are not familiar with the source or the subject line, or contain an unexpected attachment.

As mentioned, in some situations, it may not be desirable to delete unopened messages from those with whom the recipient is not familiar. Accordingly, the fear of infection from virus, theft of personal information, and other wrongdoing gives average Internet users little choice in how to manage their incoming email. Additionally, opening links to websites, authentic or otherwise may also allow wrongdoers to download malicious code, such as keylogger code, into an unsuspecting user's computer. In fact, users may not be certain if a particular link is truly a link to the URL of the claimed associated website, and may be victimized by phishing.

It would be beneficial if a user could forward unopened email messages, links and/or URLs to a service provider for analysis which could determine if an email message, link and/or URL is configured to download malicious executable code or are rightfully associated with the proclaimed URL. It would also be beneficial if a user could receive an indication from the service provider that it has determined that the email message and/or the link to the URL contain no malicious executable code and/or is authentic. In that case, the user may comfortably open the email message or follow the link to the website.

### BRIEF DESCRIPTION OF THE DRAWINGS

FIG. 1 is a flowchart of a server of a service provider that provides the analysis of an email or a website to determine whether it is configured to download malicious executable code to a computer;

FIG. 2 depicts steps in an interface and a method for processing an email message;

FIG. 3 shows a user interface 302 including an alert indicator;

FIG. 4 shows a user interface including indicia on the user interface for transmitting a link to the website to a server for determining whether the website is configured to download malicious executable code; and

FIG. 5 is a signal flow diagram including a user and/or other entity and a server.

### DETAILED DESCRIPTION

Described are methods of a server and for processing an email message. Also described are user interfaces. A user may forward an unopened email message, link and/or URL to a service provider for analysis of whether the unopened email message or URL is configured to download executable code or contains other malicious payload. The service provider may operate with a server. In one embodiment, the server may determine if executable code is present in the email message and/or is downloadable via a website. The executable code may be determined to be malicious. It is also described that after a service provider has determined whether the email message and/or the URL is configured to download malicious executable code, the user can receive a message indicating the outcome of the analysis.

More particularly, described is a method of a server, including receiving an unopened email message forwarded from an email account and opening the unopened email message to determine the content of the email. The method further includes determining whether the content of the email message contains executable code. It may then be determined whether the email message may include malicious executable code or other malicious payload. An alert may be transmitted to the forwarder of the unopened email message providing the determination of whether the content of the email message contains executable code, and in particular malicious executable code or other malicious payload.

Another embodiment is a method of processing an email message, including receiving an email message in an email account and selecting the unopened email message to forward the email message unopened. The method of processing an unopened email message includes forwarding the unopened email message to a server for analysis. The analysis includes determining whether the content of the forwarded unopened email message contains executable code. It may then be determined whether the email message may include malicious executable code or other malicious payload. The outcome of the analysis may be transmitted to the user so that the user may know whether it is safe to open the subject email.

In a user interface embodiment, an email account user interface can include indicia indicating an unopened received email message and selection option indicia for a selecting the received unopened email message. A user interface may also include forwarding indicia for forwarding a selected unopened email message to a server to determine whether the content of the email message contains executable code that may be malicious or include other malicious payload. Also, the user interface may provide an alert including the outcome of the analysis.

In embodiments directed to analyzing websites for malicious executable code, a method of a server includes receiving a link to a URL and “following the link” to the URL to determine the content of the associated website. The method further includes determining whether the website is configured to download executable code that may be malicious and transmitting an alert to the user including the outcome of the analysis. In another embodiment, a link to a website is analyzed for authenticity and the results of the analysis are transmitted to the forwarder.

In yet another embodiment, a user interface includes indicia indicating a link to a URL and indicia on the user interface for transmitting the link or URL to the website to a server for determining whether the website is configured to download malicious executable code or other malicious payload.

In the above-described methods and interfaces, once the server has transmitted a notification that the email or the website is not configured to download malicious executable code or a link to a website is authentic the user may comfortably open the email message or follow the link to the website.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of synchronization of secret flagged data across data folders of applications installed on a communication device described herein. The non-processor circuits may include, but are not limited to, a radio receiver, a radio transmitter, signal drivers, clock circuits, power source circuits, and user input devices. As such, these functions may be interpreted as steps of a method to perform synchronization of secret flagged data across data folders of applications installed on a communication device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

This invention may be embodied in the form of any number of computer-implemented processes and apparatuses for practicing those processes. Embodiments of the invention may be in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

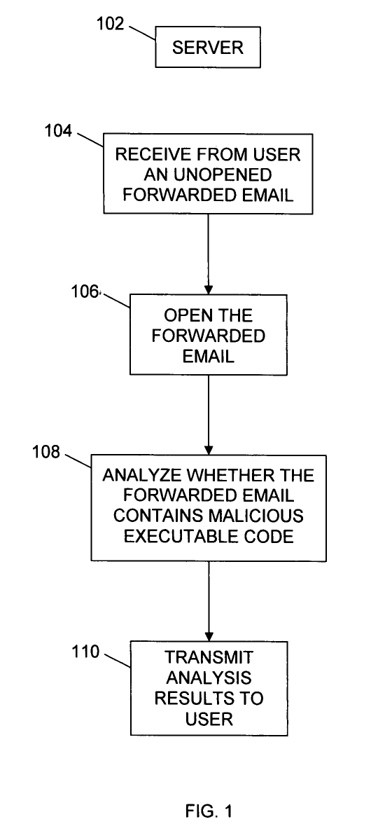

FIG. 1 is a flowchart of a server of a service provider that provides the analysis of the email and/or a website to determine whether it is configured to download malicious executable code or other malicious payload to a computer. The server may be depicted as a remote server 102 that may be in a wired or a wireless communication network. The server may be remote to the user's communication device. The network of course may be any type of network including an adhoc network or a WIFI network. Likewise, the server may be of any configuration. The server may be one server or a plurality of servers in communication in any arrangement. The operations of the server may be distributed among different servers or devices that may communicate in any manner. It is understood that the server depicted in FIG. 1 is for illustrative purposes. The server 102 can include a transceiver, a processor, a memory and other suitable components.

An embodiment of a method of the server 102 can include receiving from a user or other entity a forwarded unopened email message 104. The unopened email message may be of any format and from any source. Different email service providers may provide email to users in different formats and by different protocols. In general “email” is described herein, however, the received communication may be any type that is within the scope of this discussion. As is discussed below, the unopened or unaccessed communication may be received by the user or other entity via any type of communication device.

The server of the service provider can open the forwarded unopened email message 106 to determine whether the email message contains any executable code 108. The server 102 may not be able to analyze whether the email message contains any executable code unless the email is opened. However, it may be possible to analyze whether the email message is configured to download executable code without actually opening the email. It is understood that any manner in which to determine whether email message contains any executable code or payload is within the scope of this discussion. An analysis of any executable code or payload may be provided in any suitable manner to determine whether any found executable code or payload is malicious.

The email message may contain for example, a link to a website or the message may contain an attachment. Executable code may be included in an email or a website in any manner and the server may include algorithms for testing and analysis that are beyond the scope of this discussion. It is understood that the unopened email message, link and/or URL is forwarded to a server, and that the service provider can make a determination as to whether it is substantially safe to access the email message or follow a link to a website.

The malicious executable code or malicious payload may be of any type. For example, the code may be a virus, a keylogger, spyware, a worm and a Trojan horse (Trojan). As Internet usage continues to grow, users of the Internet may become susceptible to new and different malicious executable codes and malicious payload that would otherwise require patches and sophisticated anti-virus software that is downloadable to individual users' or entities' computer. New and different malicious executable codes and malicious payload may not be known at the time of this writing. Any scheme, code, trickery or other malfeasance received that can be forwarded to a server for analysis without the user or other entity becoming first victimized is within the scope of this discussion. By adding a layer of analysis through centralized analysis and clearing the most recent malicious executable codes may be detectable quickly. Centralizing in this sense may include more than one service provider offering services to analyze unopened emails, links and/or URLs. Centralized service providers may be competitive as well. The term “centralized” is meant to mean a service provider remote from a user's or other entities communication device that may operate for analysis to a plurality of communication devices. With a centralized approach, there may be an added layer of protection available to Internet users and entities against the wrongdoers.

It is understood that the user may wish to be apprised of the results of the analysis. If the analysis is negative may feel more comfortable accessing previously unopened email message or following the link to the website. Therefore, an embodiment of the method of the server may include transmitting the analysis results to the user 110. The analysis results may be transmitted to others as well. For example, law enforcement may wish to know results of analysis of malicious executable code. It is understood that there may agreements between the user and the server or service provider that allows the sender of a malicious executable code to be learned by law enforcement or other entities. An alert message to the user or other entity that forwarded the unopened email, link or URL, may take any suitable form.

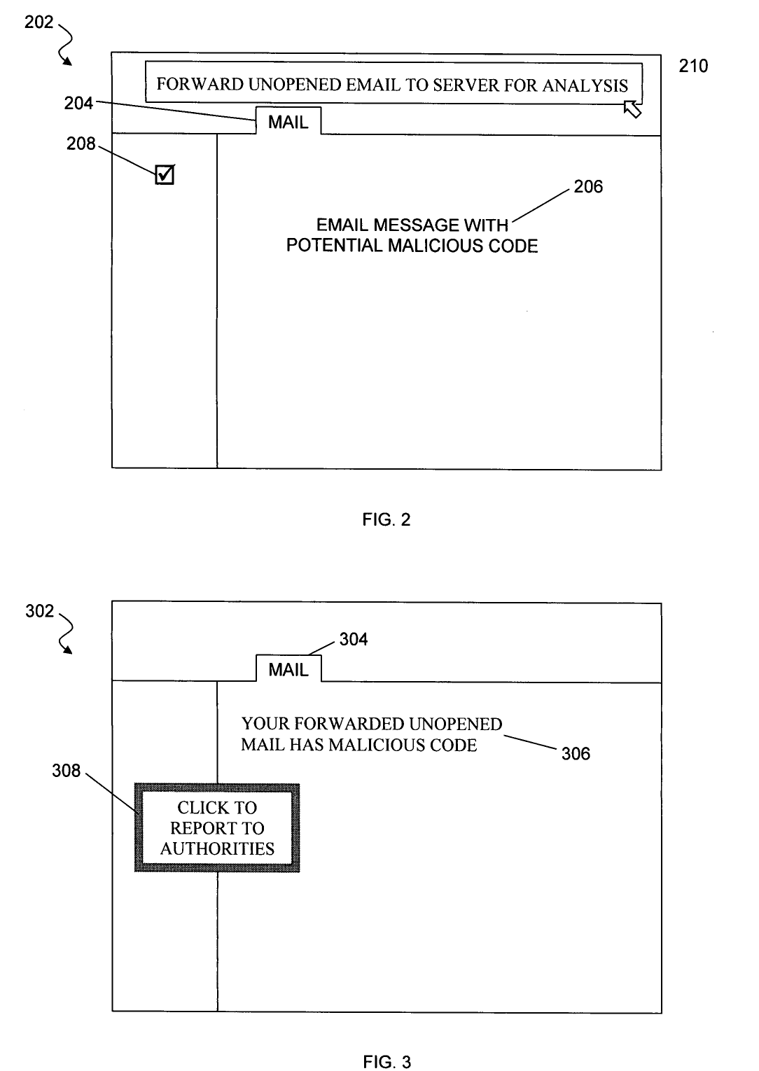

FIG. 2 depicts an interface and steps in a method for processing an email message. FIG. 2 shows a user interface that represents a generic email account screen shot 202. It is understood that a user interfaces can take any suitable form and that the user interfaces of the figures and described herein are for illustrative purposes. FIG. 2 shows is a tab 204 indicating incoming email. A received email message can be indicated on the user interface by indicia indicating a received email message 206 or other type of received communication. The unopened email message may be selected or marked to forward by selection option indicia 208. It is understood that a plurality of emails or links may be selected or marked for forwarding and forwarded. While the figure shows a checked box, the message may be marked in any manner such as highlighting and moving to another folder. Accordingly, the unopened email message may be forwarded unopened to a server for analysis as to whether it contains executable code by clicking on forwarding indicia on the user interface 210. The executable code may be found to be malicious. Either the email message or a copy of the email message may be sent. In different circumstances, a portion of the email message or a copy thereof may be sent to the server.

It is understood that any type of suitable user interface is within the scope of this discussion. For example, once marked for transmission to the server for analysis, there may be a lock on opening the item on the user's computer until a negative analysis response is received. That way, inadvertent opening of a message or link may be avoided. The item may also be moved to a separate folder to avoid inadvertent opening of a message or a link. Depending on how long the response from the server with the result of the analysis, different types of safety restrictions may be placed on suspicious items. Moreover, it may desirable to receive a confirmation of receipt by the server that the item will be analyzed.

The type of email account, browser or user interface may dictate the type of the algorithm for forwarding an unopened email message. An “email account” may in fact leave an unopened email message on a server remote to the user's communication device until via a user interface on the communication device, it is opened. Accordingly, an unopened email message may not actually reside of the communication device until opened. Even then, the act of opening the email may cause executable code to be download to the user's communication device, the email message itself never actually residing on the user's communication device. In other “email accounts” an unopened email message may be stored on the user's communication device. It is understood that the place the unopened email is stored may be a server, a user's communication device, or otherwise.

Many users use instant messaging (IM) for their email message access. IM may include email programs that receive email messages directly onto a user's computer instead of a user accessing them from an email server. IM may include email programs such as MSN MESSENGER that allow users to converse nearly in real-time.

While using IM users may trust that they are conversing with their friend or associate. Since wrongdoers are known to impersonate user's friends or associates, users may unwittingly open links or attachments that may download malicious executable code to their computer. Users may prefer to send unopened messages to the analysis server to analyze email they may otherwise trust. However, the process of conversing in nearly real-time may be slowed were a user to send each message to the server for analysis. An email program, for example, an IM program may be set up to automatically flag any incoming unopened email that contains suspicious items, much in the same way traditional email programs flag messages with attachments. Suspicious items can include but are not limited to attachments, links, graphics files or any embedded components that may contain executable code or other malicious payload. It may then be up to the user to select or mark the unopened email for transmission to the server for analysis of whether the unopened email contains executable code including malicious code. Alternatively, or in addition, an email program may by prompt or automatically send any unopened email messages with, for example, attachments, links, graphics files or other suspicious items to the server for analysis.

The described manual, prompted and automatic forwarding may be used for any type of email program, account, browser or user interface as well. Accordingly, the steps of selecting or marking the unopened email message to forward may be manual, prompted or automatic. Furthermore, the step of forwarding the unopened email message to a server for analysis as to whether it contains executable code may be manual or automatic. As discussed with respect to FIG. 1 the forwarded unopened email message can be received by the server for analysis, and processed by the server to determine whether the content of the email message contains executable code, and in particular malicious executable code or other malicious payload.

Automatic, semi-automatic, prompted or manual forwarding may be determined by user preferences. As mentioned, forwarding may be provided by prompting. In a situation where a user may maintain a contact list, for example, and an unopened email may be received from a contact on the contact list, then a preference may be to prompt the user whether the user wishes to forward the unopened email message or link for analysis. The user may chose to forward all email messages from those not on the contact list or only certain ones. For example, filters may be provided that may verify origin of unopened email messages as well as may determine suspicious items of the unopened email messages. It is understood that any user preferences, algorithms and/or prompting may help a user determine whether to forward an unopened email message for analysis. Furthermore, it is understood that any algorithms, process and prompting may be used to select or mark and forward unopened email message to the server for analysis.

FIG. 3 shows a user interface 302 including an alert indicator. The user interface is shown in connection with an email account having a mail tab 304. It is understood that an alert indicator may be provided to a user or entity in any manner. For example, an alert indicator may in the form of a pop-up screen like those used in anti-virus software to alert the user of the determination of malicious executable code. Also as shown an email message may be received from the service provider or server can include a malicious executable code alert indicator 306. In any event, the alert can be configured to indicate whether a selected unopened email message previously forwarded to a server was analyzed to contain malicious executable code.

The user interface may further include an option to report the malicious executable code to authorities 308. A report may be made by the server or by the user, or both. Furthermore, other alerts may be available, such as alerting those of the contact list of the user or the entity.

As mentioned above, the same malicious executable code analysis by a centralized service provider may analyze URLs and links websites as well. Alternatively, a different service provider may analyze different malicious executable code or malicious payload depending upon various factors so that a user or other entity may forward for analysis an unopened email message received in an email account. Moreover, a user may be alerted to malcode or malicious payload associated with the forwarded unopened email and/or may be alerted to a negative analysis result. As discussed above, a URL link may be embedded in an email message.

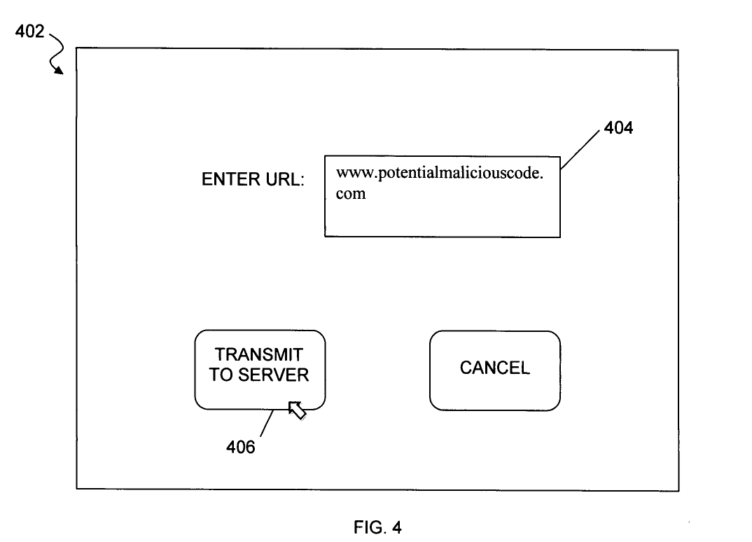

Additionally, a URL or an unopened or unfollowed link may be transmitted to server for analysis. While unopened or unfollowed links may be sent, opened URLs and links may be sent as well. FIG. 4 shows a user interface 402 including indicia for transmitting the link and/or URL of a website to a server to determine whether the website is configured to download malicious executable code or malicious payload 404. The link may be copied into the interface 404 or typed. A method of a server also includes receiving a link and/or URL of a website, following a link or URL to the website and determining whether the website is configured to download executable code that may be found to be malicious or otherwise includes malicious payload.

The process of sending URLs for analysis of malicious executable code may be performed manually, prompted or automatically. For example, if there were a filter on the incoming email program to find URL links in email messages, they may be prompted or automatically copied and sent to the server for analysis for malicious executable code.

The process of sending URLs for analysis of malicious executable code may also be performed automatically when a user is visiting suspicious websites. For example, if a user were to access certain types of websites, there may be greater likelihood that malicious executable code would be downloaded by opening a link to suspicious websites. There may a filter installed on the user device to determine suspicious URLs so that sending the URLs to the server for analysis can be automatic.

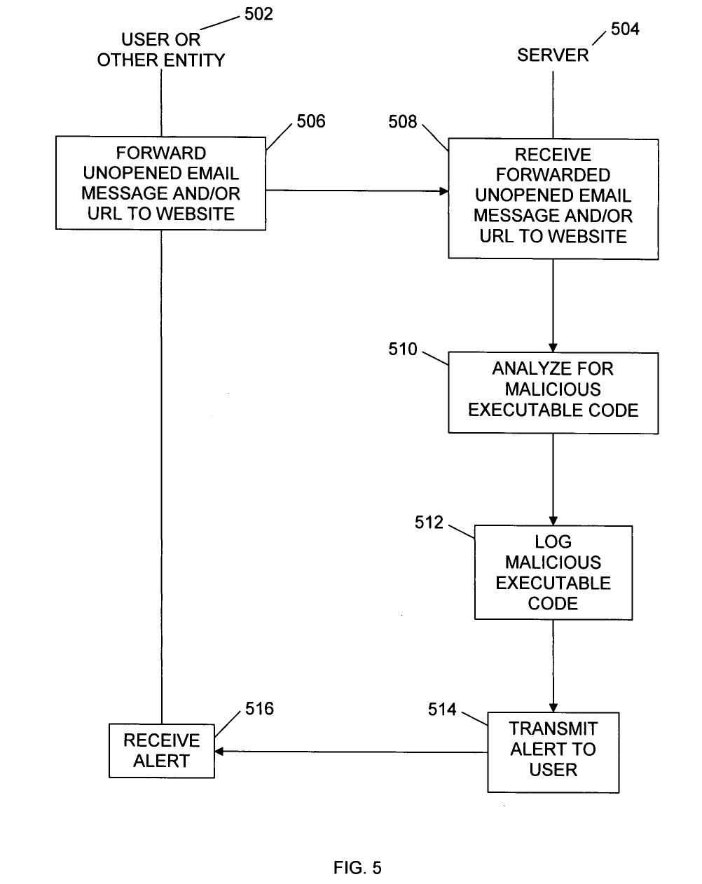

FIG. 5 is a signal flow diagram including a user and/or other entity 502 and a server 504. As described above, an unopened email message, link and/or a URL that may be falsely associated with a URL of a legitimate, or any other potential malicious payload such as malicious executable code enabled communication vehicles are forwarded to a service provider 506. The server receives the communication 508. The server analyzes for executable code and malicious payload, and whether the code is found to be malicious, logs the findings, and transmits the result to the user or other entity 514. The user or other entity receives the results analysis 516.

While many service providers offer spam and malcode filtering services for email, those are rarely available to users not affiliated with organizations having substantial number of users. The organizations typically contract with the filtering services. The filtering services may use state of the art filters to process each email before it is delivered to its end receiver. Likewise, IT departments of corporations may add more filters and scanners in-house to avoid the latest malcode.

Smaller organizations or individual users may instead rely on the less sophisticated filtering available through average email accounts some types of which were described above. While many types of spam and malcode may be determined by service providers of email accounts, it is recommended to install the latest patches and scanning software to avoid the newest malcode threats. Diligence in installing the latest patches and scanning software is often required. Individual users or small organization user are less likely to install the latest patches to avoid the latest malcode since diligence is necessary. Accordingly, users are oftentimes victims of various types of malcode and phishing schemes via their own incoming email received in email accounts. Also, with all the filtering and diligence, organization email users still may be victimized as are non-organizational users. In this way, having an opportunity forward suspicious emails, links and/or URLs to a server for analysis, can give the non-organizational users as well as organizational users the opportunity for “on-demand” analysis. Additionally, users may receive an alert message of any suitable format or manner to indicate whether the forwarded unopened email message contained executable code, or whether the forward URL contained executable code, or whether a link is falsely associated with a URL of a legitimate website or any other type of malicious payload. In the event that the analysis was negative, the user may comfortably open the email message or follow the link to the website.

Filters for virus' and other malicious code may be used in conjunction with above-described technology. In the case where incoming unopened email is parsed, for example, for attachments, links, graphics, and other suspicious items the transmission of the unopened email to the server for analysis may be prompted, automatic or manual. Likewise, when a user is surfing, a filter may determine a suspicious URL and the above-described technology may be used to transmit the link and/or URL to the server for analysis prompted, automatically or manually. The analysis for executable code by the server may be performed in any suitable manner. The service provider of the server may be more able to identify malicious executable code than software stored on a user's device. The service provider may make it a business to keep up with all the different types of malicious executable code that are introduced and circulated via the Internet or other downloading processes. After identified as suspicious once it has been received by the user, and then forwarded to the server, the server for analyzing forwarded unopened emails and links may be in a better position to arrest the propagation of malicious code or malicious payload before it becomes a threat to large numbers of users and other entities than would a user by simply deleting the suspicious message.

It is understood that the above-described methods and interfaces may be used in a wired and/or wireless environment. The defining line between wired and wireless has become blurred since oftentimes Internet travels over both. It is understood that communication device or device is meant to include any type of communication device. Since mobile communication devices include Internet capabilities, SMS messaging, are Bluetooth and WIFI enabled, they are also susceptible to the malicious executable code as are wired or wireless computers including for example, personal computers and laptops. A mobile communication device may be for example, a cellular telephone. A mobile communication device represents a wide variety of devices that have been developed for use within various networks. Such handheld communication devices can include, for example, cellular telephones, messaging devices, mobile telephones, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless communication technologies may include, for example, voice communication, the capability of transferring high content data, SMS messaging, Internet access, multi-media content access and/or voice over internet protocol (VoIP). It is understood that any and all platforms are within the scope of this discussion.

Accordingly, a method of a server my include receiving an unopened email message forwarded from an email account, opening the unopened email message to determine the content of the email, and determining whether the content of the email message contains executable code. The method of a server may further include determining whether the content of the email message contains executable code and opening a link within the email message to determine whether the link leads to a website that downloads malicious executable code. The method may further include processing the executable code to determine its type. The method may further include determining whether the executable code is a virus, determining whether the executable code is a keylogging program, determining whether the executable code is malicious executable code. Also, the method may include transmitting an alert message to the email account to indicate whether the forwarded unopened email message contained executable code and wherein receiving an unopened email message forwarded from an email account may include receiving a copy of an unopened email message forwarded from an email account.

According a user interface of a communication device may include indicia indicating an unopened link to a website and indicia on the user interface for affecting transmission of the unopened link to the website to a server for determining whether the website is configured to download malicious executable code. The user interface may further include indicia of a malicious executable code alert indicator received from the server configured to indicate whether the website is configured to download malicious executable code.

Accordingly, a method of processing an email message may include receiving an unopened email message including a suspicious item in an email account, selecting the unopened email message including a suspicious item to forward the unopened email message and forwarding the unopened email message including a suspicious item to a server for analysis as to whether it contains executable code. A method may also include forwarding the unopened email message including a suspicious item to a server for analysis as to whether it contains executable code and forwarding a copy of the unopened email message. The method may include that forwarding includes automatically forwarding the unopened email message including a suspicious item to a server for analysis as to whether it contains executable code and receiving an alert message to indicate whether the forwarded unopened email message contains executable code.

Accordingly, a method of a communication device for transmitting a URL to a server may include indicating a link to be transmitted to the server, forwarding the link to the server to determine whether a link is falsely associated with a URL of a legitimate website and receiving an alert message indicate whether the link is falsely associated with a URL of a legitimate website. Also, the method may include indicating on a user interface of the communication device the alert message whether a link is falsely associated with a URL of a legitimate website. Also a method may include wherein forwarding includes prompting the forwarding the link from the communication device to the server to determine whether a link is falsely associated with a URL of a legitimate website.

Accordingly, a method of a user interface for transmitting a URL to a server may include indicating indicia of a link to be transmitted on a user interface of a communication device, forwarding indicia for affecting the forwarding of the link to a server to determine whether a link is falsely associated with a URL of a legitimate website, and alert indicia for receiving an alert message to indicate whether the link is falsely associated with a URL of a legitimate website. Also, the user interface may include forwarding indicia that includes indicia for prompting the forwarding the link to the server to determine whether a link is falsely associated with a URL of a legitimate website.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method of processing an email message, comprising:
receiving an unopened email message in an email account;
selecting the unopened email message to forward the email message unopened; and
forwarding the unopened email message to a server for analysis as to whether it contains executable code.

2. The method of claim 2, wherein forwarding the unopened email message to a server for analysis, comprises:
automatically forwarding the unopened email message to a server for analysis.

3. The method of claim 1, wherein forwarding the unopened email message to a server for analysis, comprises:
forwarding a copy of the unopened email message to the server.

4. The method of claim 1, further comprising:
receiving by the server an unopened email message forwarded from the email account;
opening the email message to determine the content of the email message; and
determining whether the content of the email message contains executable code.

5. The method of claim 4, further comprising:
processing the executable code to determine whether the executable code type is of a malicious type.

6. The method of claim 4, further comprising:
following a link within the email message to determine whether the content of the email message contains executable code.

7. The method of claim 6, further comprising:
processing the executable code to determine whether the executable code type is of a malicious type.

8. The method claim 1, further comprising:
transmitting an alert message to indicate whether the forwarded unopened email message contained executable code.

9. An email account user interface, comprising:
indicia indicating a received unopened email message;
selection option indicia to mark the received unopened email message; and
forwarding indicia on the user interface for forwarding a marked unopened email message to a server to determine whether the content of the forwarded unopened email message contains executable code.

10. An interface of claim 9, wherein the forwarding indicia on the user interface is for forwarding a copy of a marked unopened email message to the server.

11. An interface of claim 9, wherein the forwarding indicia on the user interface for forwarding a marked unopened email message to a server is to determine whether the content of the email message contains malicious executable code.

12. An interface of claim 9, further comprising:
an executable code alert indicator configured to indicate whether the forwarded unopened email message contained executable code.

13. A method of processing URL, comprising:
receiving on a communication device an unopened email including a URL;
opening the unopened email to reveal the URL;
indicating a URL to be transmitted via a user interface associated with a communication device without accessing the URL; and
forwarding the URL to a server to determine whether a website associated with the URL is configured to download malicious executable code.

14. The method of claim 13, further comprising:
receiving an alert message from the server indicate whether the forwarded unopened email message contained executable code.

15. The method of claim 13, wherein forwarding is performed automatically.

16. The method of claim 13, further comprising:
receiving by a server the URL to a website forwarded from a user associated with a remote communication device;
following a link of the URL to the website; and
determining whether the website is configured to download executable code.

17. The method of claim 16, further comprising:
transmitting an alert message to the user associated with the remote communication device to indicate whether the website of the URL contained executable code.

18. The method of claim 16, further comprising:
processing the executable code to determine whether the executable code type is of a malicious type.
